(19) United States
(12) Patent Application Publication
(10) Pub. No.: US 2013/0141398 A1
(43) Pub. Date: Jun. 6, 2013

(54) DEVICE FOR MEASURING WRITING PRESSURE OF ELECTRONIC PEN

(71) Applicants: Kyoung Ik CHO, Daejeon (KR); Sang Seok Lee, Daejeon (KR); Seongdeok Ahn, Daejeon (KR)

(72) Inventors: Kyoung Ik CHO, Daejeon (KR); Sang Seok Lee, Daejeon (KR); Seongdeok Ahn, Daejeon (KR)

(73) Assignee: Electronics and Telecommunications Research Institute, Daejeon (KR)

(21) Appl. No.: 13/535,507

(22) Filed: Jun. 28, 2012

(30) Foreign Application Priority Data
Dec. 2, 2011 (KR) 10-2011-0128294

(51) Int. Cl. G06F 3/033

(52) U.S. Cl. 345/179; 178/19.03

(57) ABSTRACT

A device for measuring a writing pressure of electronic pen using a change of capacitance is disclosed. The device for measuring a writing pressure of electronic pen may include first and second fixed plates; a moving plate which constitutes a capacitive sensor together with the first and second fixed plates and moves between the first and second fixed plates according to a change of writing pressure; a tip which adheres to the moving plate to generate a writing pressure; and an elastic body restoring the moving plate to an original location when the moving plate moves from between the first and second fixed plates in a first direction.

### CROSS-REFERENCE TO RELATED APPLICATIONS

This U.S. non-provisional patent application claims priority under 35 U.S.C. §119 of Korean Patent Application No. 10-2011-0128294, filed on Dec. 2, 2011, the entire contents of which are hereby incorporated by reference.

### BACKGROUND

The present inventive concept herein relates to electronic pens, and more particularly, to a device for measuring a writing pressure of electronic pen that can measure a writing pressure of pen using a change of capacitance.

A typical input device in a computer may be a mouse and the oldest input device may be an electronic pen. To use a tablet pen like a mouse, a button function is needed.

The depth and width of color expressed by a pen may be changed according to a force being applied to a pen. A force applied in a pen is called a writing pressure and a measurement of writing pressure is needed to make an expression like actual pen on a tablet.

Conventional methods of measuring a writing pressure are as follows.

First, there is a method of measuring a writing pressure using a force sensing resistor (FSR) sensor.

In a conventional device, a FSR sensor of which a resistance is changed by a force is used to express a writing pressure. That is, using a characteristic of FSR that a resistance is changed according to an applied force, a writing pressure can be obtained by installing a sensor on a touch part of electronic pen. If a writing pressure does not exist in a pen while a repetitive motion is performed at a high speed, a force should be measured to be 0 by the sensor. However, it is difficult that a force is completely disappeared when a pen is detached.

A conventional device for measuring a writing pressure may have a structural problem that a force appears to be increasing even when a uniform force is applied. That is, the FSR sensor is difficult to be used as a high precision because a creep characteristic is not good.

Second, there is a method of measuring a writing pressure using a capacitive sensor.

If a space between two electrodes is changed, a change of capacitance C occurs between the two electrodes. The change of capacitance may be represented by a following formula.

C=ε₀εₛS/d-->ΔC=ε₀εₛS/d²Δd [mathematical formula 1]

Here, the ε₀ is a dielectric permittivity, the εₛ is a relative dielectric permittivity, the S is an electrode area and the d is an electrode space. If using that principle, a capacitive sensor is adopted in a pressure measuring part of electronic pen as a structure like FIG. 1 which will be described later, a writing pressure which changes in real time can be measured.

In the above method, a space d between two electrodes is changed by a change of force and a writing pressure is measured by measuring a capacitive change due to the change of space d. To realize the method, a material having an elastic body should be inserted between the two electrodes and a creep characteristic should be disappeared. However, the method has a disadvantage that it is difficult to use or realize the elastic body.

### SUMMARY

Embodiments of the inventive concept provide a device for measuring a writing pressure of electronic pen. The device may include first and second fixed plates; a moving plate which constitutes a capacitive sensor together with the first and second fixed plates and moves between the first and second fixed plates according to a change of writing pressure; a tip which adheres to the moving plate to generate a writing pressure; and an elastic body restoring the moving plate to an original location when the moving plate moves from between the first and second fixed plates in a first direction.

Embodiments of the inventive concept also provide a method of measuring a writing pressure of electronic pen. The method may include preparing first and second fixed plates; preparing a moving plate which constitutes a capacitive sensor together with the first and second fixed plates and moves between the first and second fixed plates according to a change of writing pressure; generating a writing pressure through a tip which adheres to the moving plate; and measuring a change of capacitance corresponding to the amount of movement when the moving plate moves from between the first and second fixed plates in a first direction.

Embodiments of the inventive concept also provide a device for measuring a writing pressure of electronic pen. The device may include first and second fixed plates having a square form; a moving plate which constituting a capacitive sensor together with the first and second fixed plates and slides according to a change of writing pressure; a conductive tip which adheres to the moving plate to generate a writing pressure; and an elastic body having an elastic force for restoring the moving plate to an original location when the moving plate moves from between the first and second fixed plates in a first direction as the conductive tip moves.

### BRIEF DESCRIPTION OF THE FIGURES

Preferred embodiments of the inventive concept will be described below in more detail with reference to the accompanying drawings. The embodiments of the inventive concept may, however, be embodied in different forms and should not be constructed as limited to the embodiments set forth herein. Rather, these embodiments are provided so that this disclosure will be thorough and complete, and will fully convey the scope of the inventive concept to those skilled in the art. Like numbers refer to like elements throughout.

FIG. 1 is a structure of electronic pen in accordance with a conventional art.

FIG. 2 is an illustration illustrating a measurement of capacitance change in accordance with a technical operation principle of the inventive concept.

FIG. 3 is a drawing illustrating a structure of writing pressure measuring device of electronic pen and an electronic pen.

FIG. 4 is a drawing suggested for explaining a measurement of capacitance of electronic pen in accordance with FIG. 3.

### DETAILED DESCRIPTION OF THE EMBODIMENTS

Embodiments of inventive concepts will be described more fully hereinafter with reference to the accompanying drawings, in which embodiments of the invention are shown. This inventive concept may, however, be embodied in many different forms and should not be construed as limited to the embodiments set forth herein. Rather, these embodiments are provided so that this disclosure will be thorough and complete, and will fully convey the scope of the inventive concept to those skilled in the art. In the drawings, the size and relative sizes of layers and regions may be exaggerated for clarity. Like numbers refer to like elements throughout.

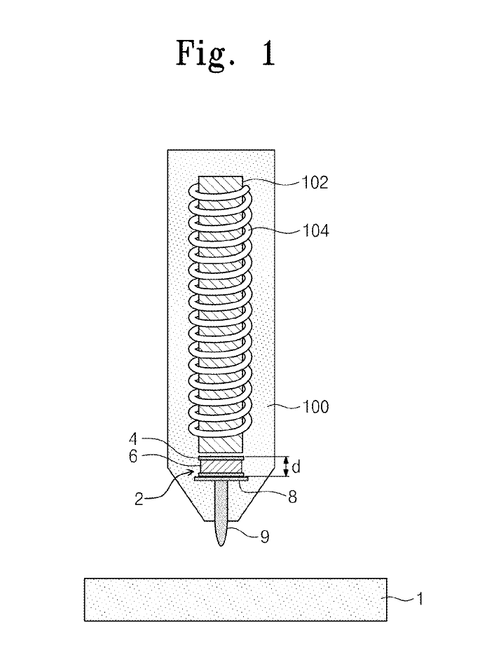

FIG. 1 is a structure of electronic pen in accordance with a conventional art.

Referring to a device 2 for measuring a writing pressure of electronic pen 100 has a structure that an elastic body 6 is inserted between two electrodes 4 and 8. A writing pressure generated from a tip 9 with respect to a tablet 1 is detected by measuring a capacitive change according to a space change of the two electrodes 4 and 8. A coil 104 and an electric conductor 102 in a housing of the electronic pen 100 are elements making a capacitance be generated.

In the structure of FIG. 1, there is a burden of inserting an elastic body between two electrodes and it is difficult not to have a creep characteristic in a small interval.

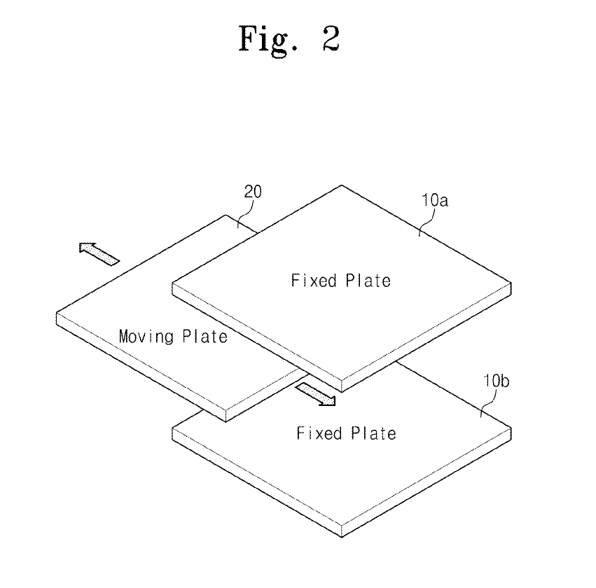

Thus, in case of embodiments of the inventive concept, a structure having a principle like FIG. 2 is suggested.

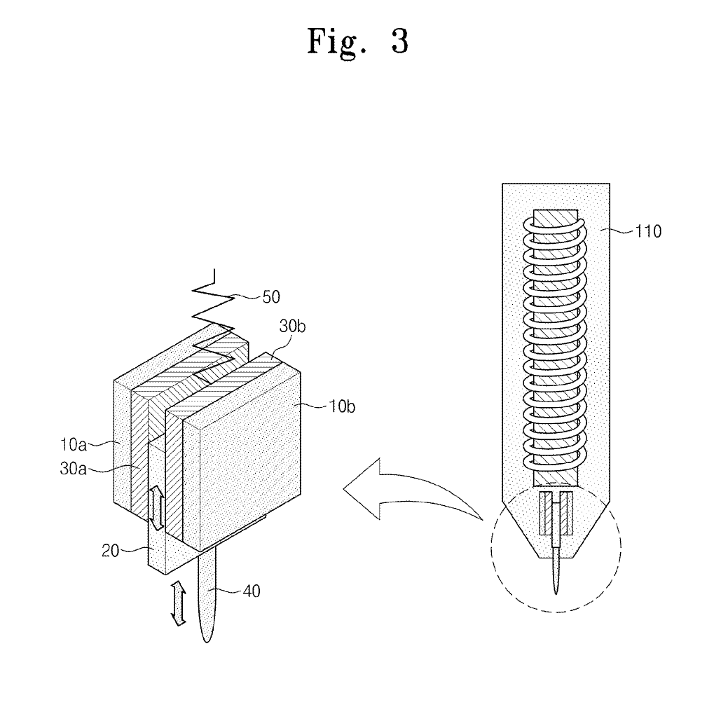

A function of electronic pen is to measure a touch location of pen and a writing pressure of pen. To measure a high precision writing pressure, it is difficult to use a conventional force sensor or the structure of FIG. 1. In the inventive concept, a high precision writing pressure measuring device of electronic pen having a simple structure is suggested in FIG. 3 according to an operation principle shown in FIG. 2.

FIG. 2 is an illustration illustrating a measurement of capacitance change in accordance with a technical operation principle of the inventive concept.

Referring to FIG. 2, a moving plate 20 moves in first and second directions between first and second fixed plates 10a and 10b. When the moving plate 20 moves in the first direction, a restoration of the moving plate 20 to an original location may be performed by an elastic body. The elastic body performs a function of moving the moving plate 20 in the second direction which is opposite to the first direction. Displacement of the moving plate 20 in the first direction is expressed by a capacitive change and a writing pressure is measured by measuring the capacitive change.

FIG. 3 is a drawing illustrating a structure of writing pressure measuring device of electronic pen and an electronic pen.

Using the operation principle shown in FIG. 2, a writing pressure measuring device and an electronic pen illustrated in FIG. 3 can be embodied.

Referring to FIG. 3, a writing pressure measuring device of electronic pen includes first and second fixed plates 10a and 10b, a moving plate 20 constituting a capacitive sensor together with the first and second fixed plates 10a and 10b and moving according to a change of writing pressure between the first and second fixed plates 10a and 10b, a tip 40 adhering to the moving plate 20 to generate a writing pressure and an elastic body 50 for restoring the moving plate 20 to an original location when the moving plate 20 moves in the first direction between the first and second fixed plates 10a and 10b.

Spacer 30a and 30b may be further included which are located between the first and second fixed plates and more smoothly moves the moving plate 20.

Since the elastic body 50 is formed on one side of the moving plate without being located between the first and second fixed plates 10a and 10b, it has a margin of moving operation or making. The elastic body 50 may be made by steel having an inherent elastic constant or a spring having a material of stainless steel.

An electronic pen 110 of FIG. 3 may be used as an input pen of tablet personal computer.

In FIG. 3, a capacitive sensor is constituted by a structure that the moving plate 20 to which the tip 40 of electronic pen adheres is located between the two fixed plates 10a and 10b and the spaces 30a and 30b for smoothing a movement of the moving plate 20 are inserted between the two fixed plates 10a and 10b. The elastic body 50 restores the moving plate 20 to an original location when the moving plate 20 is displaced. One end of the elastic body 50 is not disposed between the fixed plates 10a and 10b. Thus, a spring structure performing a restoration of the moving plate 20 may be manufactured in many different forms or structures.

If the writing pressure measuring device constituting the capacitive sensor like FIG. 3 is placed at a pressure measuring part of the electronic pen 110 (e.g., the front part of the electronic pen 110), a writing pressure can be measured in real time. That is, if the tip 40 of the electronic pen moves according to a writing pressure, the moving plate 20 to which the tip 40 adheres moves. As the moving plate 20 moves, capacitance between the two fixed plates 10a and 10b is changed and by measuring the change of capacitance, a writing pressure and a relative location change of the moving plate 20 with respect to the fixed plates 10a and 10b can be measured.

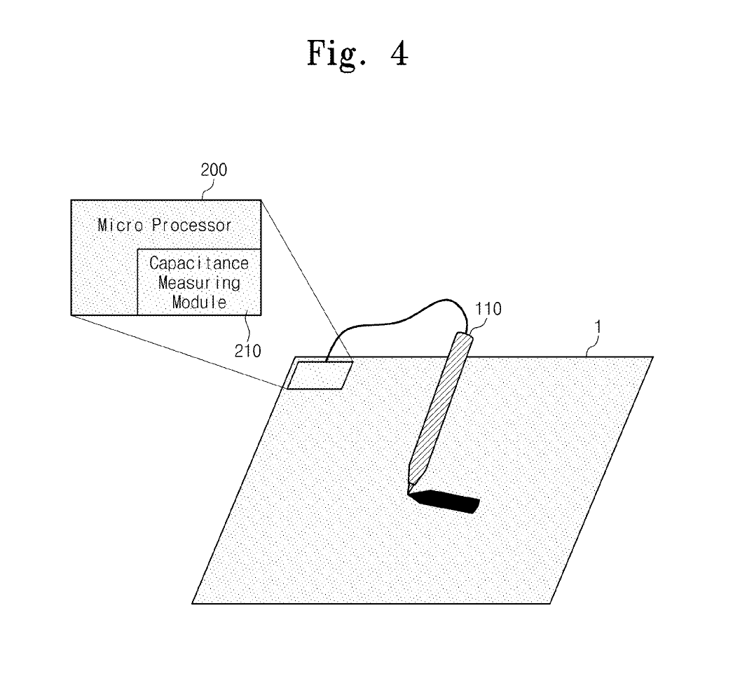

As illustrated in FIG. 4, the change of capacitance can be measured by using a microprocessor in which a module measuring capacitance is built.

FIG. 4 is a drawing suggested for explaining a measurement of capacitance of electronic pen in accordance with FIG. 3.

Referring to FIG. 4, a microprocessor 200 including a capacitance measuring module 210 is connected to an electronic pen 110 through a connection line.

Examples of measuring capacitance are a method of using RC resonance and a method of using LC resonance. In case of embodiments of the inventive concept, the capacitive sensor may be constituted so that capacitance is measured using RC resonance or so that capacitance is measured using LC resonance.

On the basis of the measuring principle described above, capacitance measured by the capacitance measuring module 210 is converted into a digital value to be provided to the microprocessor 200. Thus, the microprocessor 200 can recognize a writing pressure according to the digital value.

According to embodiments of the inventive concept, a high precision device for measuring a writing pressure of electronic pen can be manufactured which has a simple structure and a low cost and can be mass-produced.

The foregoing is illustrative of the inventive concept and is not to be construed as limiting thereof. Although a few embodiments of the inventive concept have been described, those skilled in the art will readily appreciate that many modifications are possible in the embodiments without materially departing from the novel teachings and advantages of the present invention. Accordingly, all such modifications are intended to be included within the scope of the present invention as defined in the claims. The present invention is defined by the following claims, with equivalents of the claims to be included therein

What is claimed is:

1. A device for measuring a writing pressure of electronic pen comprising:
first and second fixed plates;
a moving plate which constitutes a capacitive sensor together with the first and second fixed plates and configured to move between the first and second fixed plates according to a change of writing pressure;
a tip which adheres to the moving plate to generate a writing pressure; and
an elastic body restoring the moving plate to an original location when the moving plate moves from between the first and second fixed plates in a first direction.

2. The device for measuring a writing pressure of electronic pen of claim 1, further comprising a spacer for more smoothly moving the moving plate, the spacer being located between the first and second fixed plates.

3. The device for measuring a writing pressure of electronic pen of claim 1, wherein the elastic body is not located between the first and second fixed plates and formed on one side of the moving plate.

4. The device for measuring a writing pressure of electronic pen of claim 3, wherein the elastic body is a spring having an inherent elastic constant.

5. The device for measuring a writing pressure of electronic pen of claim 1, wherein the capacitive sensor is configured so that capacitance of the capacitive sensor is measured using RC resonance.

6. The device for measuring a writing pressure of electronic pen of claim 1, wherein the capacitive sensor is configured so that capacitance of the capacitive sensor is measured using LC resonance.

7. A device for measuring a writing pressure of electronic pen comprising:
first and second fixed plates having a square form;
a moving plate which constituting a capacitive sensor together with the first and second fixed plates and slides according to a change of writing pressure;
a conductive tip which adheres to the moving plate to generate a writing pressure; and
an elastic body having an elastic force for restoring the moving plate to an original location when the moving plate moves from between the first and second fixed plates in a first direction as the conductive tip moves.

8. The device for measuring a writing pressure of electronic pen of claim 7, further comprising an insulating spacer for more smoothly moving the moving plate, the spacer being located between the first and second fixed plates.

9. The device for measuring a writing pressure of electronic pen of claim 7, wherein the elastic body is not located between the first and second fixed plates and formed on one side of the moving plate.

10. The device for measuring a writing pressure of electronic pen of claim 9, wherein the elastic body is a stainless steel spring having an inherent elastic constant.

11. The device for measuring a writing pressure of electronic pen of claim 10, wherein the capacitive sensor is configured so that capacitance of the capacitive sensor is measured using RC resonance.

12. The device for measuring a writing pressure of electronic pen of claim 10, wherein the capacitive sensor is configured so that capacitance of the capacitive sensor is measured using LC resonance.

13. The device for measuring a writing pressure of electronic pen of claim 10, wherein the electronic pen is used as an input pen of tablet personal computer.
